(19) United States
(12) Patent Application Publication
(10) Pub. No.: US 2008/0240243 A1
(43) Pub. Date: Oct. 2, 2008

(54) Method for estimating a motion vector

(75) Inventor: Fang-Chen Chang, Tainan (TW)

Correspondence Address: BACON & THOMAS, PLLC, 625 SLATERS LANE, FOURTH FLOOR, ALEXANDRIA, VA, 22314-1176, US

(73) Assignee: HIMAX TECHNOLOGIES LIMITED, Tainan (TW)

(21) Appl. No.: 11/730,232

(22) Filed: Mar. 30, 2007

(51) Int. Cl. H04B 1/66

(52) U.S. Cl. 375/240.16; 375/E07.123

(57) ABSTRACT

A method for estimating a motion vector is provided. The method is for estimating a motion vector for a current block with reference to a number of candidate blocks in a reference frame. The method includes the steps of: firstly, determine an error between the current block and each candidate blocks according to an error function. The error function combining a DC difference and a couple of AC differences between the current block and each candidate blocks. Then, determine the candidate block having the lowest error as a matching block of the current block. Next, determine the motion vector for the current block based on a displacement between the current block and the matching block.

### BACKGROUND OF THE INVENTION

1. Field of the Invention

The invention relates in general to a method for estimating a motion vector, and more particularly to a method for estimating a motion vector for a current block employing an error function combining a DC difference and AC differences between the current block and a number of candidate blocks.

2. Description of the Related Art

Motion estimation is essential to video compression like MPEG and H.26x video compression. In a conventional method for estimating the motion vector for a current block, an SAD (sum of absolute difference) operation is provided to equally accumulate the pixel-by-pixel absolute differences between the current block and each of the candidate blocks in the reference frame.

The candidate block having the lowest SAD output is determined as the matching block, so that the displacement between the matching block and the current block can be defined as the motion vector for the current block. However, it is known that the SAD operation equally accumulates the pixel-by-pixel absolute differences, which would tend to estimate the motion vector mistakenly due to luminance change and noise interference between different frames. Therefore, it is highly desired to provide a new method for estimating the motion vector for the current block, which could accurately determine the matching block and thus the motion vector.

### SUMMARY OF THE INVENTION

The invention is directed to a method for estimating a motion vector for a current block with reference to a number of candidate blocks in a reference frame. The method of the present invention employs an error function combining the DC difference and the AC differences between the current block and each candidate block to obtaining more precise errors. The matching block can be accurately determined by applying the error. Hence, the method of the present invention estimates the motion vector for the current block precisely.

According to (a first aspect on the present invention, a method for estimating a motion vector is provided. The method is for estimating a motion vector for a current block with reference to a number of candidate blocks in a reference frame. The method includes the steps of: firstly, determine an error between the current block and each candidate blocks according to an error function. The error function combining a DC difference and a couple of AC differences between the current block and each candidate blocks. Then, determine the candidate block having the lowest error as a matching block of the current block. Next, determine the motion vector for the current block based on a displacement between the current block and the matching block.

The invention will become apparent from the following detailed description of the preferred but non-limiting embodiments. The following description is made with reference to the accompanying drawings.

### BRIEF DESCRIPTION OF THE DRAWINGS

FIG. 1 is a flowchart of the method for estimating a motion vector according to an embodiment of the present invention.

FIG. 2A is a diagram of estimating a motion vector for a current block in a current frame with reference to candidate blocks in a reference frame according to the method of FIG. 1.

FIG. 2B is a diagram indicating the displacement between the current 221 and the candidate block 213.

### DETAILED DESCRIPTION OF THE INVENTION

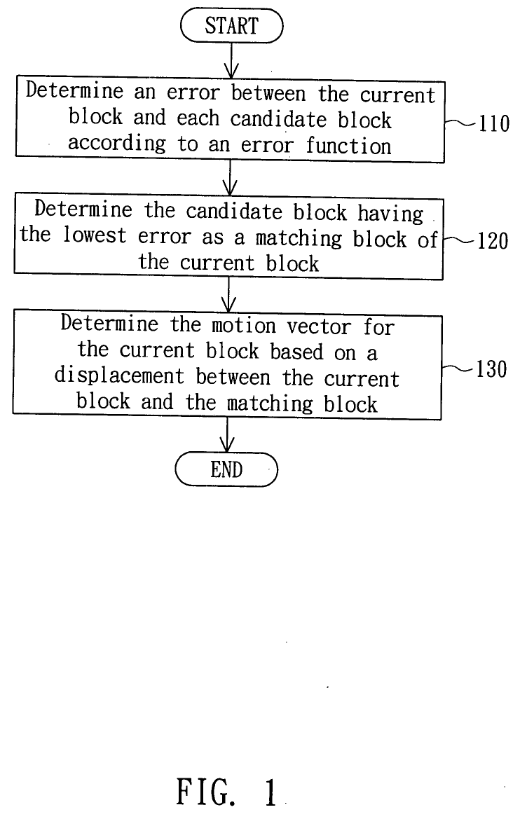

Refer to FIG. 1, a flow chart of the method for estimating a motion vector according to the embodiment of the present invention is shown. The method is for estimating a motion vector for a current block in a current image with reference to a number of candidate blocks in a reference frame.

Firstly, in step 110, determine an error between the current block and each of the candidate blocks according to an error function. The error function combines a DC difference and a number of AC differences between the current block and each of the candidate blocks.

Then in step 120, determine the candidate block having the lowest error as a matching block of the current block. Afterwards, in step 130, determine the motion vector for the current block based on a displacement between the current block and the matching block.

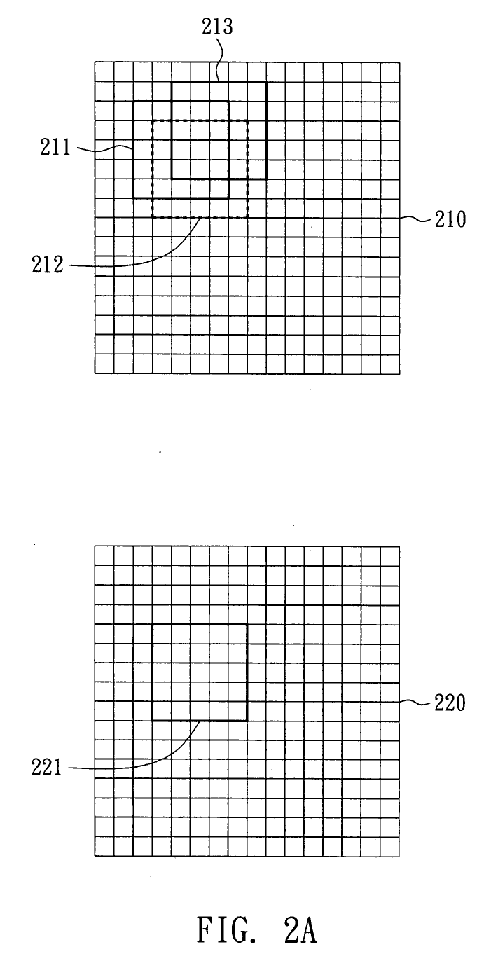

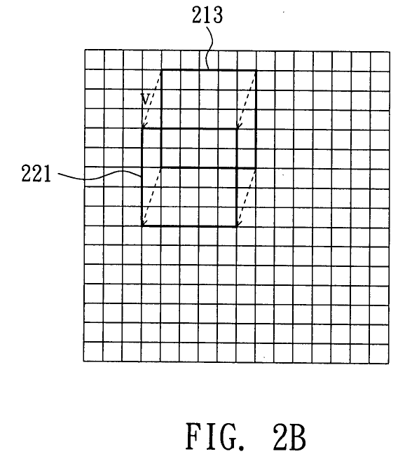

FIG. 2A is a diagram of estimating a motion vector for a current block in a current frame with reference to candidate blocks in a reference frame according to the method of FIG. 1. Refer to FIG. 2A. The method according to the embodiment of the present invention is exemplified by estimating a motion vector for the current block 221 in the current frame 220 with reference to the candidate blocks 211, 212, and 213 in the reference frame 210.

In step 110, determine an error e1 between the current block 221 and the candidate block 211, an error e2 between the current block 221 and the candidate block 212, and an error e3 between the current block 221 and the candidate block 213 according to an error function.

$$e ( v , Bc ) = \vert mean\_c - mean\_p \vert + {\sum }_{x ∈ Bc}^{ } \vert ( Fc ( x ) - mean\_c ) - ( Fr ( x - v ) - mean\_p ) \vert \qquad Formula 1$$

Formula 1 is an example of the error function combining a DC difference and a number of AC differences between the current block and a candidate block. Take the calculation of the error e3 between the current block 221 and the candidate block 213 as an example to explain formula 1. In formula 1, Bc denotes the current block 221. e(Bc,v) denotes the error between the current block 221 and the candidate block 213 from which the current block 221 displaces by a displacement v. FIG. 2B shows a diagram indicating the displacement between the current 221 and the candidate block 213. mean_c and mean_p are respectively the DC luminance components in the current block 221 and the candidate block 213, that is, the average luminances of the current block 221 and the candidate block 213. Fc (x) denotes the pixel value of a pixel x within the current block 221, where the pixel x is one of pixels in the current block 221. The pixel x is also regarded as the pixel located at the position x within the current frame 220.

Fr (x−v) denotes the pixel value of a pixel x−v within the candidate block 213 and corresponding to the pixel x. The pixel x−v corresponding to the pixel x is located at the position x−v within the reference frame 210, which means the displacement from the pixel x−v within the candidate block 213 to the pixel x within the current block 221 is v. The displacements from the different reference blocks, such as the candidate blocks 211, 212 and 213 of FIG. 2A, to the current block 221 are different.

The DC difference between the current block 221 and the candidate block 213 is |mean_c−mean_p|, which means the absolute difference between the DC luminance components in the current block 221 and the candidate block 213.

The AC difference between the pixel x in the current block 221 and the corresponding pixel x−v in the candidate block is |(Fc(x)−mean_c)−(Fr(x−v)−mean_p)|, which means the absolute difference between AC luminance component (Fc(x)−mean_c) corresponding to the pixel x in the current block 221, and the AC luminance component (Fr(x−v)−mean_p) corresponding to the pixel x−v in the candidate block 213. The AC luminance component (Fc(x)−mean_c) means the difference between the pixel value Fc(x) of the pixel x and the DC luminance component mean_c in the current block 221. The AC luminance component (Fr(x−v)−mean_p) means the difference between the pixel value Fr(x−v) of the pixel x−v and the DC luminance component mean_p in the candidate block 213. The AC differences between the current block 221 and the candidate block 213 are calculated on a pixel-to-pixel basis. Therefore, each pixel in the current block 221 and its corresponding pixel in the candidate block 213 is associated with one of the AC differences.

In formula 1, the error function obtains the error e3 between the current block 221 and the candidate block 213 by accumulating the DC difference between the current block 221 and the candidate block 213, and each AC difference between each pixel in the current block 221 and its corresponding pixel in the candidate block 213.

The errors e1 and e2 are obtained in similar way. In step 120, determine the candidate block having the lowest error as the matching block of the current block 221. For instance, when the error e3 is lowest error, the candidate block 213 is determined as the matching block. Then in step 130, determine the motion vector for the current block 221 based on the displacement v between the current block 221 and the matching block 213.

The AC luminance components of the current block are the differences between each pixel in the current block and its average luminance, while the AC luminance components of the candidate block are the differences between each pixel in the candidate block and its average luminance. For the current block and its matching block, each AC luminance component of the current block and the corresponding AC luminance component of the matching block are similar, even the average luminance of the current block is biased from the average luminance of the matching block. Therefore, each AC difference between each pixel in the current block and its corresponding pixel in the matching block is low, and consequently the error between the current block and the matching block is lowest.

Thus, by combining the DC difference and the AC differences, the error function is capable of obtaining a precise error between the current block and each candidate block, even there are luminance change and noise interference between different frames. The matching block can be more accurately determined by applying the error function in comparison with the conventional SAD operation, which only equally accumulates the pixel-by-pixel absolute differences. Hence, the method of estimating a motion vector according to the embodiment of the present invention estimates the motion vector for the current block precisely.

The error function combining the DC difference and the AC differences between the current block and the candidate block is exemplified by formula 1. However, the error function used in the method of the present invention is not limited to formula 1. Any error function combining the DC difference and the AC differences between the current block and the candidate block can be used in the method of the present invention.

The method for estimating a motion vector according to the embodiment of the present invention is exemplified by comparing the current block 221 with the three candidate blocks 211, 212, and 213. However, in practical application, the method for estimating a motion vector is not limited to the comparison between the current block and the three candidate blocks. Different number of different candidate blocks will do as well. In the embodiment of the present invention, the size of the current block 221 and the candidate blocks 211, 212 and 213 is exemplified by 5×5 blocks. However, in practical application, the size of the current block and the size of the candidate block are not limited thereto.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for estimating a motion vector for a current block with reference to a plurality of candidate blocks in a reference frame, comprising the steps of:
determining an error between the current block and each of the candidate blocks according to an error function, the error function combining a DC difference and a plurality of AC differences between the current block and each of the candidate blocks;
determining the candidate block having the lowest error as a matching block of the current block; and
determining the motion vector for the current block based on a displacement between the current block and the matching block.

2. The method according to claim 1, wherein the DC difference is the absolute difference between DC luminance components in the current block and each of the candidate blocks, and each of the AC differences is the absolute difference between AC luminance components in the current block and each of the candidate blocks, on a pixel-to-pixel basis.

3. The method according to claim 1, wherein the error function is provided to accumulate the DC difference and each of the AC differences.
